(19) United States
(12) Patent Application Publication
(10) Pub. No.: US 2026/0111994 A1
(43) Pub. Date: Apr. 23, 2026

(54) METHOD AND APPARATUS FOR OBTAINING CAMERA DATA, AUGMENTED REALITY DEVICE, AND STORAGE MEDIUM

(71) Applicant: GOERTEK INC., Weifang (CN)

(72) Inventors: Baocheng LI, Weifang (CN); Mingming YANG, Weifang (CN); Yuying WANG, Weifang (CN); Xudong QIU, Weifang (CN); Yaocheng LIU, Weifang (CN)

(21) Appl. No.: 19/423,953

(22) Filed: Dec. 17, 2025

Related U.S. Application Data
(63) Continuation of application No. PCT/CN2025/093115, filed on May 7, 2025.

(30) Foreign Application Priority Data
Jun. 26, 2024 (CN) 202410840973.X

(51) Int. Cl. G06T 1/60; G06T 11/00

(52) U.S. Cl. CPC G06T 1/60; G06T 11/00

(57) ABSTRACT

A method for obtaining camera data includes: receiving a camera access request and designating a camera requested to be accessed as a target camera; in response to that the target camera is not in use when receiving the camera access request, operating a system camera support component, obtaining image stream captured by the target camera through the system camera support component, caching the image stream to a preset address, and obtaining the camera data of the target camera from the preset address; or in response to that the target camera is already in use when receiving the camera access request, creating a virtual camera support component, copying the preset address as a first access interface into the virtual camera support component, operating the virtual camera support component, and obtaining the camera data of the target camera through the first access interface.

### CROSS-REFERENCE TO RELATED APPLICATIONS

This application is a continuation application of International Application No. PCT/CN2025/093115, filed on May 7, 2025, which claims priority to Chinese Patent Application No. 202410840973.X, filed on Jun. 26, 2024. The disclosures of the above-mentioned applications are incorporated herein by reference in their entireties.

### TECHNICAL FIELD

The present application relates to the technical field of augmented reality, and in particular to a method and an apparatus for obtaining camera data, an augmented reality device, and a storage medium.

### BACKGROUND

Augmented Reality (AR) devices can overlay real-world environments and virtual videos onto the same screen or space in real time for the wearer to view. Common AR devices include AR glasses or AR helmets.

However, camera systems of the current AR device only support one camera being used by a single process. That is, only one process is allowed to obtain the camera data captured by the camera. For example, if an AR device uses a certain camera for gesture control, it cannot use the same camera for barcode scanning, object tracking, etc. Other processes will be disconnected from the previous process through certain strategies to ensure that the same camera is used by only one process.

### SUMMARY

The main purpose of the present application is to provide a method and an apparatus for obtaining camera data, an augmented reality device, and a storage medium, which aims to solve the technical problem that the same camera in current AR device can only be used by one process.

In order to achieve the above purpose, the present application provides a method for obtaining camera data, applied to an augmented reality device, including:
receiving a camera access request and designating a camera requested to be accessed as a target camera;
in response to that the target camera is not in use when receiving the camera access request, operating a system camera support component, obtaining image stream captured by the target camera through the system camera support component, caching the image stream to a preset address, and obtaining the camera data of the target camera from the preset address; or
in response to that the target camera is already in use when receiving the camera access request, creating a virtual camera support component, copying the preset address as a first access interface into the virtual camera support component, operating the virtual camera support component, and obtaining the camera data of the target camera through the first access interface.

In an embodiment, before operating the virtual camera support component, the method further includes:
obtaining pre-configured streaming access interfaces of all camera configuration streams, designating the streaming access interfaces of all camera configuration streams as a second access interface, and copying the second access interface into the virtual camera support component;
the obtaining the camera data of the target camera through the first access interface includes:
obtaining all camera configuration streams through the second access interface, and selecting a first camera configuration stream from all the camera configuration streams; and
accessing the cached image stream through the first access interface, and obtaining the camera data of the target camera from the cached image stream based on the first camera configuration stream.

In an embodiment, the selecting the first camera configuration stream from all the camera configuration streams includes:
obtaining a first configuration parameter encapsulated in the camera access request; and
selecting the camera configuration stream with a highest matching degree with the first configuration parameter from all camera configuration streams as the first camera configuration stream, where the more configuration parameters in the camera configuration stream that are consistent with the first configuration parameter, the higher the matching degree between the camera configuration stream and the first configuration parameter.

In an embodiment, the obtaining the camera data of the target camera from the cached image stream based on the first camera configuration stream includes:
in response to that the configuration parameters contained in the first camera configuration stream are all consistent with the first configuration parameter, obtaining at least one frame of image from the cached image stream based on the first camera configuration stream as the camera data obtained from the target camera; or
in response to that the configuration parameters contained in the first camera configuration stream are inconsistent with the first configuration parameter, obtaining at least one frame of image from the cached image stream based on the first camera configuration stream, performing image conversion on all obtained images, and designating the converted image as the camera data obtained from the target camera, where an image parameter of the converted image is the first configuration parameter.

In an embodiment, the obtaining the image stream captured by the target camera includes:
obtaining all configuration parameter groups based on the camera access request, wherein each configuration parameter group includes one or more configuration parameters;
configuring a camera configuration stream based on each configuration parameter group, where each configuration parameter group corresponds to one camera configuration stream;
selecting one camera configuration stream from all the camera configuration streams and designating the selected camera configuration stream as a target camera configuration stream; and
obtaining the image stream captured by the target camera based on the target camera configuration stream.

In an embodiment, the selecting one camera configuration stream from all the camera configuration streams and designating the selected camera configuration stream as the target camera configuration stream includes:
designating the camera configuration stream obtained from all the camera configuration streams based on the configuration parameters encapsulated in the camera access request as the target camera configuration stream.

In an embodiment, after caching the image stream to the preset address, the method further includes:
uploading the image stream to a preset server, and receiving the camera access request;
after designating the camera requested to be accessed as the target camera, the method further includes:
determining an application requesting access to the target camera based on the camera access request; and
in response to that the application requesting access to the target camera is a non-native application, obtaining the camera data of the target camera from the image stream uploaded to the preset server.

In addition, in order to achieve the above objective, the present application further provides an apparatus for obtaining camera data, including:
a receiving module, configured for receiving a camera access request and designating a camera requested to be accessed as a target camera;
a sharing module, configured for in response to that the target camera is not in use when receiving the camera access request, operating a system camera support component, obtaining image stream captured by the target camera through the system camera support component, caching the image stream to a preset address, and obtaining the camera data of the target camera from the preset address; and
an obtaining module, configured for in response to that the target camera is already in use when receiving the camera access request, creating a virtual camera support component, copying the preset address as a first access interface into the virtual camera support component, operating the virtual camera support component, and obtaining the camera data of the target camera through the first access interface.

In addition, in order to achieve the above objective, the present application further provides an augmented reality device, including a microphone array and a processor, the microphone array is electrically connected to the processor; the processor is configured to execute the method for obtaining camera data as described above.

In addition, in order to achieve the above objective, the present application further provides a readable storage medium, a program for obtaining camera data is stored on the readable storage medium, and the program for obtaining the camera data, when executed by a processor, implements the method for obtaining the camera data as described above.

The present application also provides a computer program product, including a computer program that, when executed by a processor, implements the method for obtaining the camera data as described above.

The present application provides a method for obtaining the camera data, including: receiving a camera access request and designating a camera requested to be accessed as a target camera; in response to that the target camera is not in use when receiving the camera access request, operating a system camera support component, obtaining image stream captured by the target camera through the system camera support component, caching the image stream to a preset address, and obtaining the camera data of the target camera from the preset address; or in response to that the target camera is already in use when receiving the camera access request, creating a virtual camera support component, copying the preset address as a first access interface into the virtual camera support component, operating the virtual camera support component, and obtaining the camera data of the target camera through the first access interface. As such, in the embodiments of the present application, when the target camera is not in use, the image stream captured by the target camera is buffered. Since the camera system of AR devices requires that the camera support component can only provide the image stream of the same camera to one process, when a subsequent process accesses the target camera, the present application creates a virtual camera support component to obtain the camera data from the cached image stream through the virtual camera support component, instead of using the system camera support component to obtain the image stream of the target camera. Thus, the process that initially uses the target camera and the process that uses the target camera again each obtain the camera data based on an independent camera support component, realizing that the same camera of the AR device can be shared and used by multiple processes. For example, when an AR device plays an Original Sound Track (OST) based on the captured current scene, or when using Virtual Studio Technology (VST) to edit and process audio content in an AR experience based on the captured current scene, gesture control can be supported simultaneously.

### BRIEF DESCRIPTION OF THE DRAWINGS

The accompanying drawings, which are incorporated into and constitute a part of this specification, illustrate embodiments consistent with the present application and, together with the description, serve to explain the principles of the present application.

To more clearly illustrate the embodiments of the present application or the technical solutions in the related art, the following briefly describes the drawings required for the embodiments or descriptions of the related art. It is obvious that those skilled in the art could derive other drawings based on these drawings without inventive effort.

FIG. 1 is a flowchart illustrating a method for obtaining camera data according to an embodiment of the present application.

FIG. 2 is a simplified flowchart illustrating the method for obtaining camera data according to an embodiment of the present application.

FIG. 3 is a flowchart illustrating the method for obtaining camera data according to another embodiment of the present application.

FIG. 4 is a schematic structural diagram of an apparatus for obtaining camera data according to an embodiment of the present application.

FIG. 5 is a schematic diagram of the hardware operating environment of the apparatus for obtaining camera data in the embodiments of the present application.

FIG. 6 is a flowchart illustrating the method for obtaining camera data according to another embodiment of the present application.

FIG. 7 is a flowchart illustrating the method for obtaining camera data according to another embodiment of the present application.

FIG. 8 is a flowchart illustrating the method for obtaining camera data according to another embodiment of the present application.

FIG. 9 is a flowchart illustrating the method for obtaining camera data according to another embodiment of the present application.

FIG. 10 is a flowchart illustrating the method for obtaining camera data according to another embodiment of the present application.

The objectives, features, and advantages of the present application will be further explained with reference to the accompanying drawings in conjunction with the examples.

### DETAILED DESCRIPTION OF THE EMBODIMENTS

To make the above-mentioned objects, features, and advantages of the present application more apparent and understandable, the technical solutions of the embodiments of the present application will be clearly and completely described below with reference to the accompanying drawings. Obviously, the described embodiments are only some embodiments of the present application, and not all embodiments. Based on the embodiments of the present application, all other embodiments obtained by those skilled in the art without creative effort are within the scope of the present application.

In AR devices, when one process is using the camera, other processes cannot access the camera at the same time. This is because the camera is a hardware resource, and the operating system usually does not allow two different processes to directly control the same hardware resource simultaneously.

Based on this, the main solution of the present application is: receiving a camera access request and designating a camera requested to be accessed as a target camera; in response to that the target camera is not in use when receiving the camera access request, operating a system camera support component, obtaining image stream captured by the target camera through the system camera support component, caching the image stream to a preset address, and obtaining the camera data of the target camera from the preset address; or in response to that the target camera is already in use when receiving the camera access request, creating a virtual camera support component, copying the preset address as a first access interface into the virtual camera support component, operating the virtual camera support component, and obtaining the camera data of the target camera through the first access interface.

In the present application, when the target camera is not in use, the image stream captured by the target camera is buffered. Since the camera system of AR devices requires that the camera support component can only provide the image stream of the same camera to one process, when a subsequent process accesses the target camera, the present application creates a virtual camera support component to obtain the camera data from the cached image stream through the virtual camera support component, instead of using the system camera support component to obtain the image stream of the target camera. Thus, the process that initially uses the target camera and the process that uses the target camera again each obtain the camera data based on an independent camera support component, realizing that the same camera of the AR device can be shared and used by multiple processes. For example, when an AR device plays an Original Sound Track (OST) based on the captured current scene, or when using Virtual Studio Technology (VST) to edit and process audio content in an AR experience based on the captured current scene, gesture control can be supported simultaneously.

It should be noted that the execution subject of this embodiment can be an augmented reality device capable of realizing the above functions, such as AR glasses, AR helmets, etc. For example, AR glasses are used as the execution subject to describe the various embodiments of the present application.

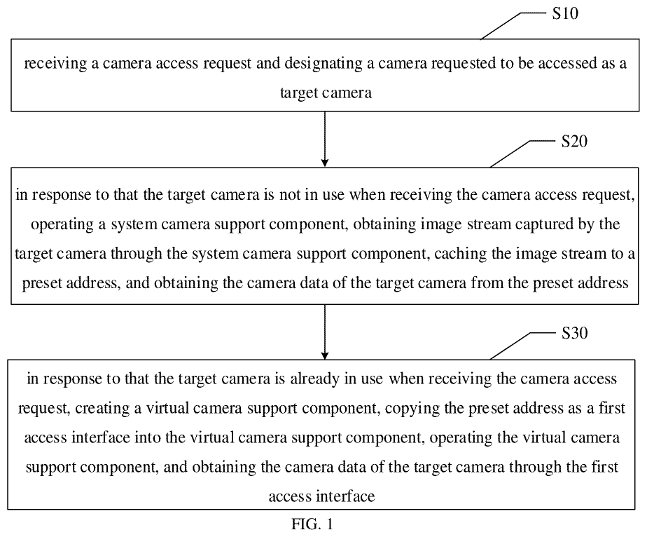

Based on this, the present application provides a method for obtaining camera data. As shown in FIG. 1, the method for obtaining camera data includes steps S10 to S30:

Step S10, receiving a camera access request and designating a camera requested to be accessed as a target camera.

It should be noted that the AR glasses can be AR glasses based on the Android camera system, but are not limited to AR glasses based on the Android camera system. For example, they can also be AR glasses based on Apple (iOS). This embodiment does not make any specific limitations on this.

It can be understood that sometimes AR glasses need to perform tasks based on camera data. For example, when AR glasses perform gesture control, they need to obtain camera data to recognize the user's gestures and then perform subsequent control based on the recognized gestures. To improve the user experience when AR glasses play OSTs, it is necessary to acquire camera data captured by the camera in order to identify the current scene of the user based on the acquired camera data, and then play the OST corresponding to that scene.

When an application in AR glasses needs to obtain video data from a certain camera, that is, when it needs to use the camera, it can initiate a camera access request for that camera through a process. Specifically, the process can encapsulate the camera identifier of the camera in the camera access request, so as to determine the target camera to be accessed in this request based on the camera identifier encapsulated in the camera access request.

It should be noted that once the process initiates a camera access request for the target camera, if the AR glasses receive this request, the process can obtain the camera data from the target camera. That is, the process starts using the target camera. During the use of the target camera, the process will no longer send camera access requests. It only needs to initiate a camera stop access request when the process no longer needs to use the target camera to terminate the continued acquisition of the camera data from the target camera, that is, to terminate the use of the target camera.

Step S20, in response to that the target camera is not in use when receiving the camera access request, operating a system camera support component, obtaining image stream captured by the target camera through the system camera support component, caching the image stream to a preset address, and obtaining the camera data of the target camera from the preset address.

For ease of explanation, if the target camera is not in use when the camera access request is received, the process accessing the target camera will be recorded as the first process accessing the target camera.

In an embodiment, the image stream consists of image frames captured by the target camera at a preset capturing frequency.

The camera data of the target camera is obtained from the image stream. Specifically, one frame, multiple frames, or all frames can be obtained from the image stream as the camera data of the target camera. It is easy to understand that different processes have different requirements for the number of image frames they need to acquire. For example, the gesture recognition process may need to acquire all image frames, while the photo-taking process may only need to acquire one image frame. Based on this, the corresponding image frame can be obtained from the image stream as the acquired camera data based on the characteristics of the process itself.

The preset address is specifically the address of the shared storage area, so that all processes can access this address and obtain the image stream cached at this preset address.

The camera system architecture consists of, in sequence, the application layer, the framework layer, the hardware abstraction layer (HAL), and the hardware layer. The HAL implements interfaces related to specific hardware. It abstracts the implementation details of different camera hardware, enabling the Android system to access camera devices from different manufacturers in a unified manner. Specifically, CameraProvider is a key system-level component of the HAL layer, responsible for managing and providing access interfaces to the camera hardware, which provides information and status of the camera devices to the upper-layer CameraManager service and handles operations such as opening, configuring, transmitting data streams, and closing the camera devices. Therefore, in this embodiment, the camera support component is CameraProvider.

In an embodiment, the system camera support component is the original CameraProvider of the camera system of the AR glasses.

Step S30, in response to that the target camera is already in use when receiving the camera access request, creating a virtual camera support component, copying the preset address as a first access interface into the virtual camera support component, operating the virtual camera support component, and obtaining the camera data of the target camera through the first access interface.

For ease of subsequent explanation, if the target camera is already in use when a camera access request is received, the process accessing the target camera is recorded as a process accessing the target camera again.

In this embodiment, the virtual camera support component is a virtual CameraProvider. A virtual CameraProvider indicates that it is not an actual CameraProvider; rather, it provides an interface for data access.

It should be noted that for each process that accesses the target camera for the first time, a corresponding virtual camera support component is created for it. However, if a virtual camera support component already exists in the AR glasses for the process that initiated the camera access request, the virtual camera support component will not be created again, and the existing virtual camera support component will be used directly. For example, suppose process B initiates a camera access request to access the target camera. At this time, process A is already using the target camera and has not found a virtual camera component created for process B. Then, a corresponding virtual camera component B is created for process B. At some point, process B initiates a request to stop accessing the camera and terminates the use of the target camera. At some point, process B initiates another request to access the target camera again. If it is found that a corresponding virtual camera component B has already been created for process B, then the virtual camera support component will not be created again, and the existing virtual camera support component B will be run directly.

In this embodiment, augmented reality devices receive camera accesses requests and designates the camera requested to be accessed as the target camera. If the target camera is not in use when the camera access request is received, the system camera support component is run to obtain the image stream captured by the target camera, the image stream is cached to a preset address, and the camera data of the target camera is then obtained from the preset address. If the target camera is already in use when the camera access request is received, a virtual camera support component is created, the preset address is copied into the virtual camera support component as the first access interface, the virtual camera support component is run, and the camera data of the target camera is obtained through the first access interface. As such, in this embodiment, when the target camera is not in use, the image stream captured by the target camera is buffered. Since the camera system of AR devices requires that the camera support component can only provide the image stream of the same camera to one process, when subsequent processes access the target camera, this embodiment creates a virtual camera support component. The virtual camera support component obtains the camera data from the cached image stream, instead of using the system camera support component to obtain the image stream of the target camera. Thus, the process that initially uses the target camera and the process that uses the target camera again subsequently obtain the camera data based on an independent camera support component, realizing that the same camera of the AR device can be shared and used by multiple processes. For example, when an AR device plays an Original Sound Track (OST) based on the captured current scene, or when using Virtual Studio Technology (VST) to edit and process audio content in an AR experience based on the captured current scene, gesture control can be supported simultaneously.

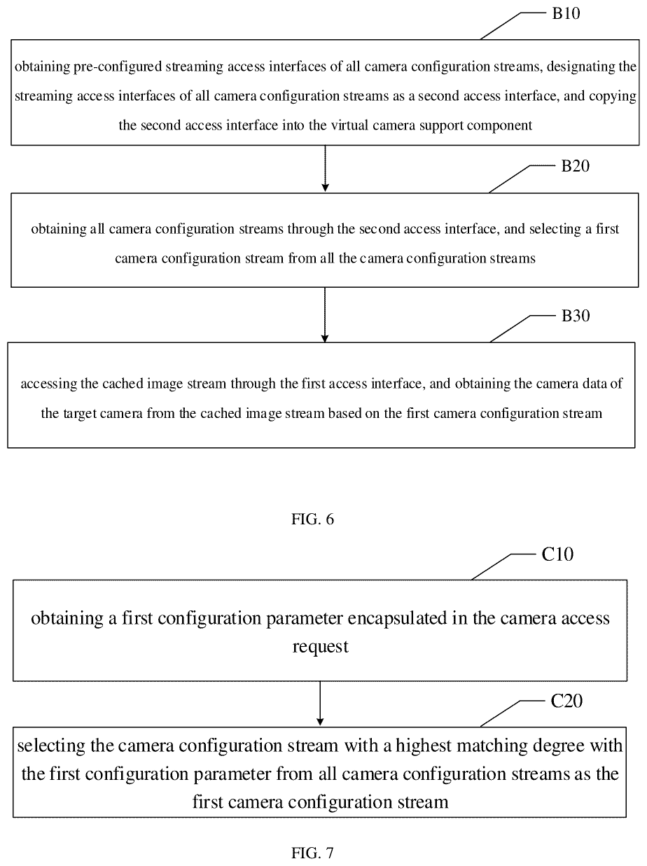

Based on the above embodiments, in another embodiment of the present application, the content that is the same as or similar to that in the above embodiments described above can be referred to the above description, and will not be repeated hereafter. Based on this, as shown in FIG. 6, before the step of operating the virtual camera support component, the method further includes:

Step B10, obtaining pre-configured streaming access interfaces of all camera configuration streams, designating the streaming access interfaces of all camera configuration streams as a second access interface, and copying the second access interface into the virtual camera support component.

In an embodiment, the pre-configured camera configuration streams can refer to all camera configuration streams (i.e., camera streams) pre-configured by the HAL layer upon initial access to the target camera.

The second access interface can specifically be the storage address of all camera configuration streams.

The step of obtaining the camera data of the target camera through the first access interface includes:

Step B20, obtaining all camera configuration streams through the second access interface, and selecting a first camera configuration stream from all the camera configuration streams.

The first camera configuration stream can be selected randomly from all camera configuration streams or selected based on preset rules from those that are not currently in use. The phrase “camera configuration stream not in use” indicates that the camera configuration stream is not currently being used by the camera system to acquire image streams.

Step B30, accessing the cached image stream through the first access interface, and obtaining the camera data of the target camera from the cached image stream based on the first camera configuration stream.

It can be understood that in a camera system, it is necessary to obtain the image stream of the camera based on the camera configuration stream. Therefore, in this embodiment, camera data is obtained from the cached image stream based on the selected first camera configuration stream.

Based on the above embodiments, in another embodiment of the present application, the content that is the same as or similar to that in the above embodiments described above can be referred to the above description, and will not be repeated hereafter. Based on this, as shown in FIG. 7, the step of selecting the first camera configuration stream from all the camera configuration streams includes:

Step C10, obtaining a first configuration parameter encapsulated in the camera access request; and

Step C20, selecting the camera configuration stream with a highest matching degree with the first configuration parameter from all camera configuration streams as the first camera configuration stream, where the more configuration parameters in the camera configuration stream that are consistent with the first configuration parameter, the higher the matching degree between the camera configuration stream and the first configuration parameter.

Furthermore, if there are multiple camera configuration streams with the highest matching degree, then any one of the multiple camera configuration streams with the highest matching degree can be selected as the first camera configuration stream.

It should be noted that for a camera configuration stream, the more configuration parameters in the camera configuration stream that are consistent with the first configuration parameter, the higher the matching degree between the camera configuration stream and the first configuration parameter.

As an implementation, the total configuration parameter that matches the first configuration parameter among all the configuration parameters contained in the camera configuration stream can be used as the matching degree between the camera configuration stream and the first camera configuration parameter. For example, assuming the first configuration parameter is [Format A, Color Space A, Resolution A], all camera configuration streams include Camera Configuration Stream A, Camera Configuration Stream B, and Camera Configuration Stream C, containing the configuration parameters [Format A, Color Space B, Resolution C], [Format A, Color Space A, Resolution B], and [Format A, Color Space A, Resolution A], respectively, then the matching degree between camera configuration stream A and the first configuration parameter is 1, the matching degree between camera configuration stream B and the first configuration parameter is 2, and the matching degree between camera configuration stream C and the first configuration parameter is 3. At this time, camera configuration stream C has the highest matching degree, so camera configuration stream C is selected as the first camera configuration stream.

As another implementation, for each configuration parameter, a corresponding weight can be set, and a weighted summation is performed based on the weights to obtain the matching degree between the camera configuration stream and the first configuration parameter. For example, assuming the first configuration parameters are [Format A, Color Space A, Resolution A], the weights for image format, color space, and resolution are 0.1, 0.7, and 0.2, respectively, all camera configuration streams include Camera Configuration Stream A, Camera Configuration Stream B, and Camera Configuration Stream C, containing configuration parameters of [Format A, Color Space B, Resolution C], [Format A, Color Space A, Resolution B], and [Format A, Color Space A, Resolution A], respectively, then the matching degree between camera configuration stream A and the first configuration parameter is 0.1, the matching degree between camera configuration stream B and the first configuration parameter is 0.8, and the matching degree between camera configuration stream C and the first configuration parameter is 1. At this time, camera configuration stream C has the highest matching degree, so camera configuration stream C is selected as the first camera configuration stream.

It should be noted that the above are just two feasible implementation methods for calculating the matching degree between the camera configuration stream and the first configuration parameter provided in this embodiment. This embodiment does not specifically limit the specific implementation method for calculating the matching degree between the camera configuration stream and the first configuration parameter.

In this embodiment, selecting the camera configuration stream with the highest matching degree to the first configuration parameter as the first camera configuration stream can be understood as follows: typically, a process encapsulates its expected data format in the form of configuration parameters within the camera access request. In this way, the data format of the image stream obtained based on the first camera configuration stream is as close as possible to the expected data format of the process accessing the target camera, that is, the matching degree between the obtained data format and the expected data format is maximized, thereby reducing the amount of subsequent data format conversion.

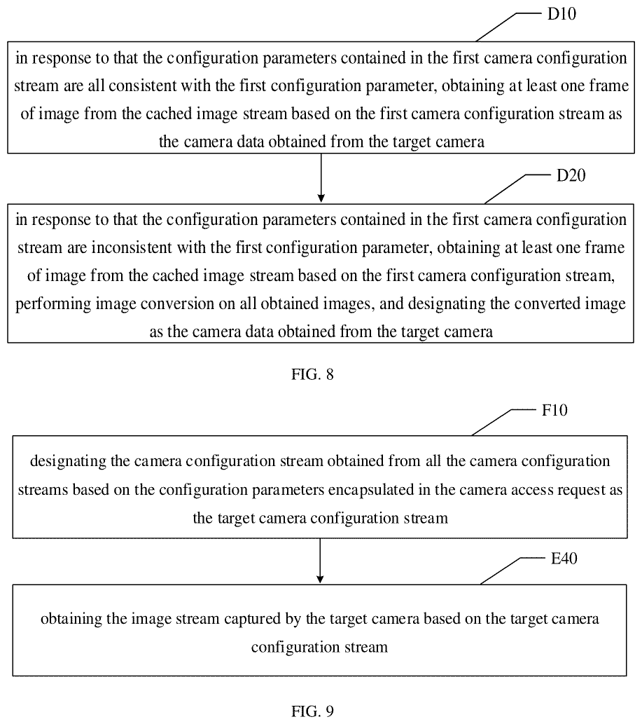

In an embodiment, as shown in FIG. 8, the step of obtaining the camera data of the target camera from the cached image stream based on the first camera configuration stream includes:

Step D10, in response to that the configuration parameters contained in the first camera configuration stream are all consistent with the first configuration parameter, obtaining at least one frame of image from the cached image stream based on the first camera configuration stream as the camera data obtained from the target camera.

The configuration parameters contained in the first camera configuration stream are identical to the first configuration parameter, meaning that the parameter values of both are identical. For example, if a configuration parameter includes image format, color space, and resolution, then the configuration parameters contained in the first camera configuration stream are identical to the first configuration parameter. That is, the image format in the first camera configuration stream is identical to the image format in the first configuration parameter, the color space in the first camera configuration stream is identical to the color space in the first configuration parameter, and the resolution in the first camera configuration stream is identical to the resolution in the first configuration parameter. Since the configuration parameters are completely identical, the image stream obtained by the first camera configuration stream is the image stream in the expected data format, and no data format conversion is required.

Step D20, in response to that the configuration parameters contained in the first camera configuration stream are inconsistent with the first configuration parameter, obtaining at least one frame of image from the cached image stream based on the first camera configuration stream, performing image conversion on all obtained images, and designating the converted image as the camera data obtained from the target camera, where an image parameter of the converted image is the first configuration parameter.

Based on the first camera configuration stream, at least one frame of image is obtained from the cached image stream. The specific number and types of frames obtained can be determined based on the process's own needs, and this implementation does not impose any specific restrictions on this.

All acquired images undergo image transformation. Specifically, transformation can be based on inconsistent configuration parameters. For example, suppose the first camera configuration stream contains configuration parameters of [image format A, color space A, resolution B], and the first configuration parameter is [image format A, color space A, resolution A]. If the image format and color space are the same, but the resolution is different, the acquired image can be scaled to scale resolution B to resolution A, so that the converted data format meets expectations.

In this embodiment, when the configuration parameters in the first camera configuration stream are inconsistent with the first configuration parameters, the image is converted to convert the image parameters such as image format, color space, and resolution into the first configuration parameters, so that the data format of the acquired camera data conforms to the process expectation.

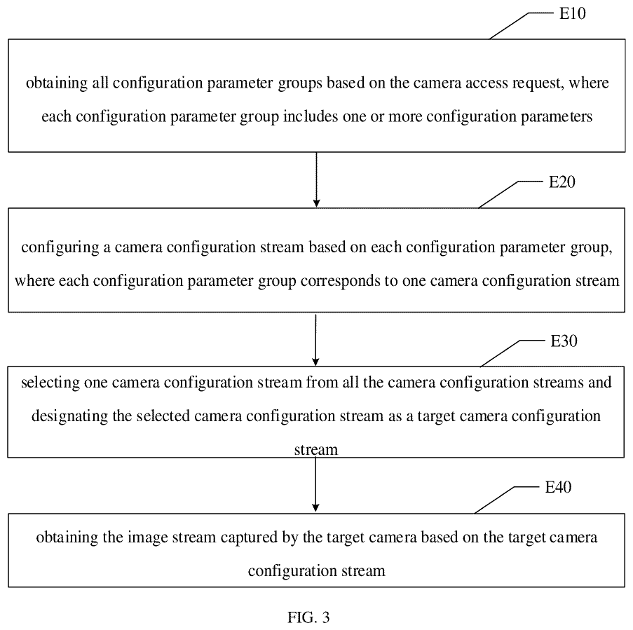

Based on the above embodiments, in another embodiment of the present application, the content that is the same as or similar to that in the above embodiments described above can be referred to the above description, and will not be repeated hereafter. Based on this, as shown in FIG. 3, the step of obtaining the image stream captured by the target camera includes:

Step E10, obtaining all configuration parameter groups based on the camera access request, where each configuration parameter group includes one or more configuration parameters.

Furthermore, when the configuration parameter group includes multiple configuration parameters, these multiple configuration parameters are multiple configuration parameters of different parameter types. Specifically, the parameter types of the configuration parameters include, but are not limited to, image format, color space, and resolution. This embodiment does not impose specific restrictions on these, and the parameter types required when configuring the camera stream (i.e., camera configuration stream) in the actual camera system shall prevail.

Further, based on different parameter types, the configuration parameters encapsulated in the camera access request and the configuration parameters supported by the AR glasses are arranged and combined to obtain all configuration parameter groups. For example, assuming each configuration parameter group includes configuration parameters of two types: image format and resolution, the configuration parameters encapsulated in the camera access request are [Format A, Resolution A]. Regarding the image format parameter, AR glasses support configuration parameters for format B and format C. For the resolution parameter type, AR glasses support the configuration parameters resolution A and resolution B. Based on different parameter types, the possible configuration parameter groups are: [Format A, Resolution A], [Format A, Resolution B], [Format B, Resolution A], [Format B, Resolution B], [Format C, Resolution A], [Format C, Resolution B].

Step E20, configuring a camera configuration stream based on each configuration parameter group, where each configuration parameter group corresponds to one camera configuration stream.

The specific configuration method for configuring the camera configuration stream in the configuration parameter group can use the existing camera configuration stream configuration method in the HAL layer of the Android camera system. The configuration process of the camera configuration stream will not be described in detail in this embodiment. It should be noted that once each camera configuration stream is configured, the camera configuration stream includes the configuration parameters in the configuration parameter group and a generated pipeline. The pipeline is a conduit within the HAL layer used to manage image data streams. It ensures that image data is transmitted efficiently and consistently, while also handling possible data format conversions. The pipeline may include multiple processing stages, such as noise reduction, white balance adjustment, color correction, cropping, and scaling. These stages help improve image quality and meet the needs of specific applications; they can be understood as a pipeline for transmitting image streams. Configuration parameters in the configuration parameter group are used to indicate the processing goals of the pipeline.

Step E30, selecting one camera configuration stream from all the camera configuration streams and designating the selected camera configuration stream as a target camera configuration stream.

When AR glasses acquire an image stream, they need to acquire it based on a camera configuration stream. Based on this, a target camera configuration stream can be randomly selected from all camera configuration streams or selected based on preset rules in order to successfully acquire the image stream.

Step E40, obtaining the image stream captured by the target camera based on the target camera configuration stream.

When acquiring an image stream based on a certain camera configuration stream, it can specifically be done by acquiring the image stream through the pipeline in this camera configuration stream. The image stream output by the pipeline has the data format of the configuration parameters. The actual acquired image stream can be understood as the stream data output after passing through the pipeline.

It can be understood that the HAL layer of the camera system can only configure the camera configuration stream once for the same camera. Based on this, in this embodiment, when receiving a camera access request from a process accessing the target camera for the first time, it not only configures the camera configuration stream according to the configuration parameters encapsulated in the camera access request, but also configures all camera configuration streams according to the configuration parameters supported by the AR glasses. In this way, the camera configuration stream for subsequent processes accessing the target camera is pre-configured, so that subsequent processes accessing the target camera can obtain image streams based on the pre-configured camera configuration stream. This allows the AR glasses to support different processes obtaining image streams based on different camera configuration streams. Since the image streams obtained by different camera configuration streams are in different formats, the AR glasses can support the acquisition of multi-format image streams, thus improving the intelligence of camera sharing.

In an embodiment, as shown in FIG. 9, the step of selecting one camera configuration stream from all the camera configuration streams and designating the selected camera configuration stream as the target camera configuration stream includes:

Step F10, designating the camera configuration stream obtained from all the camera configuration streams based on the configuration parameters encapsulated in the camera access request as the target camera configuration stream.

In this embodiment, using the camera configuration stream obtained based on the configuration parameters encapsulated in the camera access request as the target camera configuration stream, it can be understood that the process usually encapsulates the data format it expects to obtain in the form of configuration parameters in the camera access request. In this way, the data format of the image stream obtained based on the target camera configuration stream can meet the expectations of the process accessing the target camera for the first time.

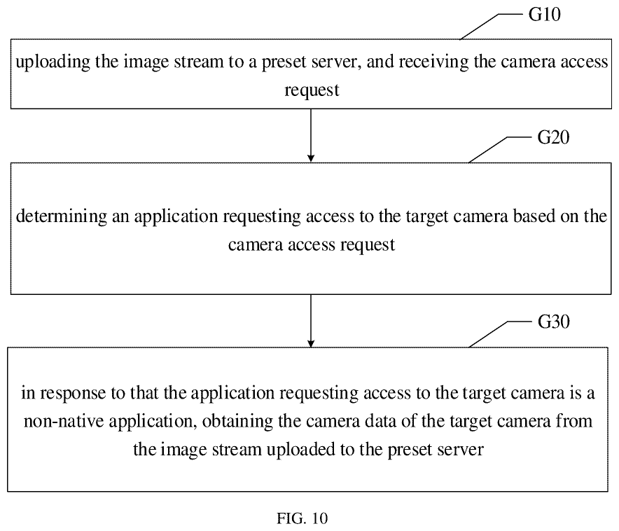

Based on the above embodiments, in another embodiment of the present application, the content that is the same as or similar to that in the above embodiments described above can be referred to the above description, and will not be repeated hereafter. Based on this, as shown in FIG. 10, after the step of caching the image stream to the preset address, the method further includes:

Step G10, uploading the image stream to a preset server, and receiving the camera access request.

Upload the image stream to the preset server; specifically, it is possible to copy the image stream to the preset server.

After designating the camera requested to be accessed as the target camera, the method further includes:

Step G20, determining an application requesting access to the target camera based on the camera access request; and

Step G30, in response to that the application requesting access to the target camera is a non-native application, obtaining the camera data of the target camera from the image stream uploaded to the preset server.

Native applications refer to applications that can run directly on the current operating system and are developed for a particular operating system, such as iOS or Android. Native applications are built using specific programming languages for specific device platforms. Non-native applications refer to applications that are distinct from native applications, such as user-defined applications and web applications. In this embodiment, non-native applications may refer to non-Android system native applications.

In this embodiment, the non-native applications obtain camera data from the preset server. This allows non-native applications to share and use the camera, and directly obtaining camera data from the preset server can improve the speed of camera data acquisition, achieving low-latency acquisition of camera data.

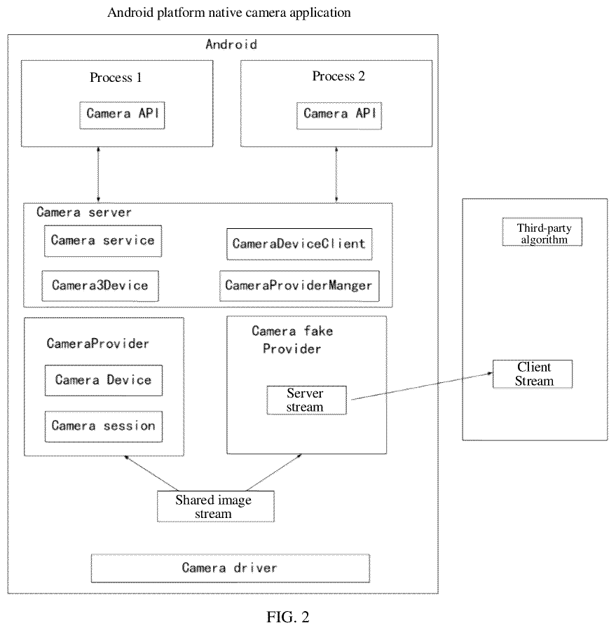

For example, to help understand the technical concept or principle of camera data acquisition in combination with the above embodiments, as shown in FIG. 2, FIG. 2 provides a simplified flowchart of the method for obtaining camera data, as follows:

Process A and process B access the same camera through the Android camera system's Camera Application Programming Interface (API). Process A and process B are processes of the native Camera application on the Android platform.

In the Camera server (system camera service) module, if a camera that is already in use is opened, since the camera system can only give the camera identifier of the same camera to one process, a virtual camera identifier is generated and passed to the HAL layer. This allows the camera system to accept the access request of that process for further processing, instead of kicking out the process that is using the camera or directly rejecting the access request of that process. The Camera server module is the native Camera server module of the Android camera system, including native Android camera system modules such as Camera service, CameraDeviceClient, Camera3Device, and CameraProviderManager.

In the Camera provider module, modify the camera opening logic. When an unused camera is opened, configure all camera streams (including all image formats, color spaces, and resolutions, and generate all pipelines) and send them to the Camera driver. Also, cache the obtained image streams. When the same camera is opened a second time, a virtual CameraProvider (the Camera fake Provider shown in FIG. 2) is created, and subsequent data sharing is achieved by retrieving camera data from the cached image stream.

The image stream is shared to the server (server stream shown in FIG. 2). When a third-party algorithm in a non-native application needs to use the camera, it obtains camera data from the server, and the image stream is transmitted from the server to the client of the non-native application (client stream shown in FIG. 2).

It should be noted that the above specific embodiments are only used to understand the present application and do not constitute a limitation on the camera data acquisition process of the present application. Any simple modifications based on this technical concept are all within the protection scope of the present application.

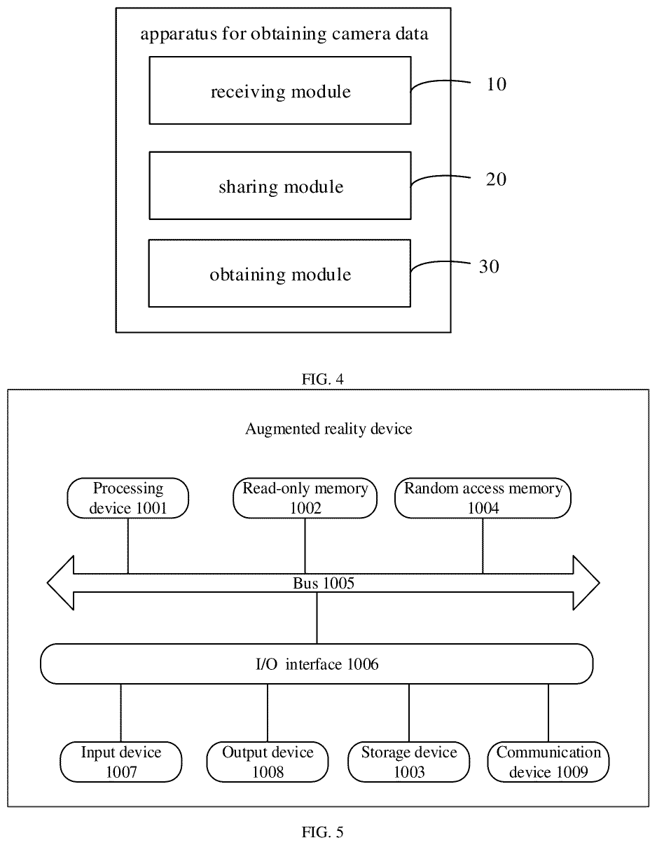

Besides, the embodiments of the present application further provide an apparatus for obtaining camera data. As shown in FIG. 4, the apparatus for obtaining camera data includes: a receiving module 10, a sharing module 20 and an obtaining module 30.

The receiving module 10 is configured for receiving a camera access request and designating a camera requested to be accessed as a target camera.

The sharing module 20 is configured for in response to that the target camera is not in use when receiving the camera access request, operating a system camera support component, obtaining image stream captured by the target camera through the system camera support component, caching the image stream to a preset address, and obtaining the camera data of the target camera from the preset address.

The obtaining module 30 is configured for in response to that the target camera is already in use when receiving the camera access request, creating a virtual camera support component, copying the preset address as a first access interface into the virtual camera support component, operating the virtual camera support component, and obtaining the camera data of the target camera through the first access interface.

Besides, as shown in FIG. 5, the augmented reality device may also include a processing unit 1001 (e.g., a central processing unit, a graphics processing unit, etc.), which can perform various appropriate actions and processes according to a program stored in read-only memory (ROM) 1002 or a program loaded from storage device 1003 into random access memory (RAM) 1004. The RAM 1004 also stores various programs and data required for the operation of the augmented reality device. The processing device 1001, ROM 1002, and RAM 1004 are interconnected via bus 1005. Input/output (I/O) interface 1006 is also connected to the bus. Typically, the following systems can be connected to I/O interface 1006: input devices 1007 including, for example, touch screens, touchpads, image sensors, microphones, accelerometers, gyroscopes, etc.; output devices 1008 including, for example, liquid crystal displays (LCDs), speakers, vibrators, etc.; storage devices 1003 including, for example, magnetic tapes, hard disks, etc.; and communication devices 1009. The communication device 1009 allows the augmented reality device to communicate wirelessly or wiredly with other devices to exchange data. While the figures show augmented reality devices with various systems, it should be understood that implementing or having all of the systems shown is not required. More or fewer systems may be implemented alternatively.

In particular, according to the embodiments disclosed in the present application, the processes described above with reference to the flowcharts can be implemented as computer software programs. For example, embodiments disclosed in the present application include a computer program product including a computer program carried on a computer-readable medium, the computer program containing program code for performing the methods shown in the flowcharts. In such embodiments, the computer program can be downloaded and installed from a network via a communication device, or installed from storage device 1003, or installed from ROM 1002. When the computer program is executed by processing device 1001, it performs the functions defined in the methods of the embodiments disclosed in the present application.

The augmented reality device provided in the present application, employing the method for obtaining camera data described in the above embodiments, can solve the technical problem of camera data acquisition. Compared with the prior art, the beneficial effects of the augmented reality device provided in the present application are the same as those of the method for obtaining camera data provided in the above embodiments, and other technical features of this augmented reality device are the same as those disclosed in the method of the previous embodiment, and will not be repeated here.

It should be understood that the various parts disclosed in the present application can be implemented using hardware, software, firmware, or a combination thereof. In the description of the above embodiments, specific features, structures, materials, or characteristics can be combined in any suitable manner in one or more embodiments or examples.

The above description is merely a specific embodiment of the present application, but the scope of the present application is not limited thereto. Any variations or substitutions that can be easily conceived by those skilled in the art within the scope of the technology disclosed in the present application should be included within the scope of the present application. Therefore, the scope of the present application should be determined by the scope of the claims.

In addition, in order to achieve the above objective, the embodiments of the present application further provide a readable storage medium having computer-readable program instructions (i.e., a computer program) stored thereon, which are used to execute the method for obtaining camera data in the above embodiments.

The computer-readable storage medium provided in the embodiments of the present application may be, for example, a USB flash drive, but is not limited to electrical, magnetic, optical, electromagnetic, infrared, or semiconductor systems or devices, or any combination thereof. More specific examples of computer-readable storage media may include, but are not limited to, an electrical connection having one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In this embodiment, the computer-readable storage medium may be any tangible medium containing or storing a program that can be used by or in conjunction with an instruction execution system or device. The program code contained on the computer-readable storage medium may be transmitted using any suitable medium, including, but not limited to, wires, optical cables, radio frequency (RF), etc., or any suitable combination thereof.

The computer-readable storage medium may be included in the device for processing vehicle road noise, or it may exist independently and not be incorporated into the device for processing vehicle road noise.

The computer-readable storage medium carries one or more programs. When one or more of the above programs are executed by the augmented reality device, the augmented reality device is configured for: receiving a camera access request and designating a camera requested to be accessed as a target camera; in response to that the target camera is not in use when receiving the camera access request, operating a system camera support component, obtaining image stream captured by the target camera through the system camera support component, caching the image stream to a preset address, and obtaining the camera data of the target camera from the preset address; or in response to that the target camera is already in use when receiving the camera access request, creating a virtual camera support component, copying the preset address as a first access interface into the virtual camera support component, operating the virtual camera support component, and obtaining the camera data of the target camera through the first access interface.

Computer program code for carrying out the operations of the present application may be written in one or more programming languages, or a combination thereof, including object-oriented programming languages such as Java, Smalltalk, and C++, as well as conventional procedural programming languages such as C or similar programming languages. The program code may execute entirely on the user's computer, partially on the user's computer, as a stand-alone software package, partially on the user's computer and partially on a remote computer, or entirely on the remote computer or server. Where a remote computer is involved, the remote computer may be connected to the user's computer through any type of network, including a local area network (LAN) or a wide area network (WAN), or may be connected to an external computer (e.g., through the Internet using an Internet service provider).

The flowcharts and block diagrams in the accompanying drawings illustrate the possible implementation architecture, functions and operations of the systems, methods and computer program products according to various embodiments of the present application. In this regard, each box in the flowchart or block diagram can represent a module, program segment or part of code, and the module, program segment or part of code contains one or more executable instructions for implementing the specified logical function. It should also be noted that in some alternative implementations, the functions marked in the box can also occur in an order different from that marked in the accompanying drawings. For example, two boxes represented in succession can actually be executed substantially in parallel, and they can sometimes be executed in the opposite order, depending on the functions involved. It should also be noted that each box in the block diagram and/or flowchart, as well as the combination of boxes in the block diagram and/or flowchart, can be implemented using a dedicated hardware-based system that performs the specified function or operation, or can be implemented using a combination of dedicated hardware and computer instructions.

The modules described in the embodiments of the present application may be implemented in software or hardware, wherein the name of a module does not necessarily limit the unit itself.

The readable storage medium provided in the embodiments of the present application is a computer-readable storage medium, which stores computer-readable program instructions (i.e., a computer program) for executing the method for obtaining camera data as described above, which can solve the technical problems of camera data acquisition. Compared with the prior art, the beneficial effects of the computer-readable storage medium provided in the embodiments of the present application are the same as the beneficial effects of the method for obtaining camera data provided in the above-mentioned embodiments, and are not further elaborated here.

Furthermore, the present application also proposes a computer program product, including a program for obtaining camera data, which, when executed by a processor, implements the steps of the method for obtaining camera data described above.

The specific implementation of the computer program product in the present application is basically the same as the embodiments of the method for obtaining camera data as described above, and will not be repeated here.

It should be noted that in this document, the terms “comprise”, “include” or any other variants thereof are intended to cover a non-exclusive inclusion. Thus, a process, method, article, or system that includes a series of elements not only includes those elements, but also includes other elements that are not explicitly listed, or also includes elements inherent to the process, method, article, or system. If there are no more restrictions, the element defined by the sentence “including a . . . ” does not exclude the existence of other identical elements in the process, method, article or system that includes the element.

The serial numbers of the foregoing embodiments of the present application are only for description, and do not represent the advantages and disadvantages of the embodiments.

Through the description of the above embodiment, those skilled in the art can clearly understand that the above-mentioned embodiments can be implemented by software plus a necessary general hardware platform, of course, it can also be implemented by hardware, but in many cases the former is a better implementation. Based on this understanding, the technical solution of the present application can be embodied in the form of software product in essence or the part that contributes to the existing technology. The computer software product is stored on a storage medium (such as ROM/RAM, magnetic disk, optical disk) as described above, including several instructions to cause a terminal device (which can be a mobile phone, a computer, a server, an air conditioner, or a network device, etc.) to execute the method described in each embodiment of the present application.

The above are only some embodiments of the present application, and do not limit the scope of the present application thereto. Under the concept of the present application, equivalent structural transformations made according to the description and drawings of the present application, or direct/indirect application in other related technical fields are included in the s

What is claimed is:

1. A method for obtaining camera data, applied to an augmented reality device, comprising:
receiving a camera access request and designating a camera requested to be accessed as a target camera;
in response to that the target camera is not in use when receiving the camera access request, operating a system camera support component, obtaining image stream captured by the target camera through the system camera support component, caching the image stream to a preset address, and obtaining the camera data of the target camera from the preset address; or
in response to that the target camera is already in use when receiving the camera access request, creating a virtual camera support component, copying the preset address as a first access interface into the virtual camera support component, operating the virtual camera support component, and obtaining the camera data of the target camera through the first access interface.

2. The method according to claim 1, wherein before operating the virtual camera support component, the method further comprises:
obtaining pre-configured streaming access interfaces of all camera configuration streams, designating the streaming access interfaces of all camera configuration streams as a second access interface, and copying the second access interface into the virtual camera support component;
the obtaining the camera data of the target camera through the first access interface comprises:
obtaining all camera configuration streams through the second access interface, and selecting a first camera configuration stream from all the camera configuration streams; and
accessing the cached image stream through the first access interface, and obtaining the camera data of the target camera from the cached image stream based on the first camera configuration stream.

3. The method according to claim 2, wherein the selecting the first camera configuration stream from all the camera configuration streams comprises:
obtaining a first configuration parameter encapsulated in the camera access request; and
selecting the camera configuration stream with a highest matching degree with the first configuration parameter from all camera configuration streams as the first camera configuration stream, wherein the more configuration parameters in the camera configuration stream that are consistent with the first configuration parameter, the higher the matching degree between the camera configuration stream and the first configuration parameter.

4. The method according to claim 3, wherein the obtaining the camera data of the target camera from the cached image stream based on the first camera configuration stream comprises:
in response to that the configuration parameters contained in the first camera configuration stream are all consistent with the first configuration parameter, obtaining at least one frame of image from the cached image stream based on the first camera configuration stream as the camera data obtained from the target camera; or
in response to that the configuration parameters contained in the first camera configuration stream are inconsistent with the first configuration parameter, obtaining at least one frame of image from the cached image stream based on the first camera configuration stream, performing image conversion on all obtained images, and designating the converted image as the camera data obtained from the target camera, wherein an image parameter of the converted image is the first configuration parameter.

5. The method according to claim 1, wherein the obtaining the image stream captured by the target camera comprises:
obtaining all configuration parameter groups based on the camera access request, wherein each configuration parameter group comprises one or more configuration parameters;
configuring a camera configuration stream based on each configuration parameter group, wherein each configuration parameter group corresponds to one camera configuration stream;
selecting one camera configuration stream from all the camera configuration streams and designating the selected camera configuration stream as a target camera configuration stream; and
obtaining the image stream captured by the target camera based on the target camera configuration stream.

6. The method according to claim 5, wherein the selecting one camera configuration stream from all the camera configuration streams and designating the selected camera configuration stream as the target camera configuration stream comprises:
designating the camera configuration stream obtained from all the camera configuration streams based on the configuration parameters encapsulated in the camera access request as the target camera configuration stream.

7. The method according to claim 1, wherein after caching the image stream to the preset address, the method further comprises:
uploading the image stream to a preset server, and receiving the camera access request;
after designating the camera requested to be accessed as the target camera, the method further comprises:
determining an application requesting access to the target camera based on the camera access request; and
in response to that the application requesting access to the target camera is a non-native application, obtaining the camera data of the target camera from the image stream uploaded to the preset server.

8. An apparatus for obtaining camera data, comprising:
a receiving module, configured for receiving a camera access request and designating a camera requested to be accessed as a target camera;
a sharing module, configured for in response to that the target camera is not in use when receiving the camera access request, operating a system camera support component, obtaining image stream captured by the target camera through the system camera support component, caching the image stream to a preset address, and obtaining the camera data of the target camera from the preset address; and
an obtaining module, configured for in response to that the target camera is already in use when receiving the camera access request, creating a virtual camera support component, copying the preset address as a first access interface into the virtual camera support component, operating the virtual camera support component, and obtaining the camera data of the target camera through the first access interface.

9. An augmented reality device, comprising:
a memory;
a processor; and
a program for obtaining camera data stored on the memory and executable on the processor,
wherein the program for obtaining camera data, when executed by the processor, implements the method for obtaining the camera data according claim 1.

10. A non-transitory computer-readable storage medium, wherein a program for obtaining camera data is stored on the non-transitory computer-readable storage medium, and the program for obtaining the camera data, when executed by a processor, implements the method for obtaining the camera data according to claim 1.
